(19) United States
(12) Patent Application Publication
(10) Pub. No.: US 2007/0116290 A1
(43) Pub. Date: May 24, 2007

(54) Method of detecting incorrect IEEE 802.11 WEP key information entered in a wireless station

(76) Inventor: Chih-Hao Yeh, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/164,090

(22) Filed: Nov. 10, 2005

(51) Int. Cl. H04K 1/00

(52) U.S. Cl. 380/270

(57) ABSTRACT

A method for verifying WEP key information for a wireless station in a wireless network containing an access point includes generating a first test data frame with the wireless station in which a destination address of the first test data frame is an address of the wireless station; encrypting the first test data frame with a first encryption key corresponding to a first encryption key ID; the access point decrypting the first test data frame, reading the destination address, re-encrypting the first test data frame, and forwarding the first test data frame back to the wireless station; the wireless station receiving the first test data frame from the access point; and determining that the first encryption key information and the first encryption key ID of the wireless station match that of the access point in response to the wireless station receiving the first test data frame from the access point.

### BACKGROUND

The invention relates to wireless local area networks (WLANs), and more particularly, to a method for verifying key information entered in a wireless station utilizing wired-equivalent privacy (WEP) encryption.

In the IEEE 802.11 standard for wireless communication, wired-equivalent privacy (WEP) is used as a tool for encrypting data before the data is transmitted wirelessly among wireless stations. A transmitting device encrypts each data frame using an encryption key, and then transmits the data frame to a destination device. In order for the receiving device to decrypt the received data frame, the receiving device must use the same key, according to key ID specified in the encrypted frame, for decrypting as the transmitting device used for encrypting.

Please refer to FIG. 1. FIG. 1 is a diagram illustrating a conventional WLAN 5. An access point 12 is connected to a local area network (LAN) 10 for creating a wireless network with wireless stations 14, 16. Each of the wireless stations 14, 16 can wirelessly receive data from the access point 12 and can also wirelessly transmit data to the access point 12.

Please refer to FIG. 2, which illustrates data frame forwarding in a WLAN. A wireless station 14 wishes to send data frame 20 to wireless station 16 via the access point 12. A simplified version of the data frame 20 is illustrated in FIG. 2. The data frame 20 contains data and three addresses: A1, A2, and A3. Address A1 indicates the immediate destination of the data frame 20, which is the access point 12. Address A2 indicates the immediate source of the data frame 20, which is the wireless station 14. Address A3 indicates the final target of the data frame 20, which is the wireless station 16.

The access point 12 receives the data frame 20 and then forwards the data frame 20 to the wireless station 16 as data frame 22. The data frame 22 also contains data and three addresses A1, A2, A3. Address A1 indicates the immediate destination of the data frame 22, which is the wireless station 16. Address A2 indicates the immediate source of the data frame 22, which is the access point 12. Address A3 indicates the original source of the data frame 22, which is the wireless station 14.

The conventional method for determining whether a wireless station associated with an access point is using incorrect key information includes measuring the number of undecipherable packets that are received during a predetermined period of time. If this number of undecipherable data frames exceeds a given threshold, then it can be concluded that the key information is incorrect. Unfortunately, this conventional method has at least two drawbacks. First of all, this method relies on traffic being generated by other devices. Secondly, the device being setup can only check the key information corresponding to a key ID that is the same as the access point's default key ID because the transmitter can choose any key ID for each transmission and most of implementations of AP only use default key ID while IEEE 802.11 allows key ID to range from 0 to 3.

Therefore, there is a need for an improved way to determine if the inputted key information for a wireless station that will communicate with an access point is incorrect.

### SUMMARY

Methods for verifying key information for a wireless station are provided. An exemplary embodiment of a method for verifying wired-equivalent privacy (WEP) key information for a wireless station in an infrastructure wireless local network comprises: generating a first test data frame with the wireless station in which a destination address of the first test data frame is an address of the wireless station; encrypting the first test data frame with a first encryption key corresponding to a first encryption key ID; the access point decrypting the first test data frame, reading the destination address, re-encrypting the first test data frame, and forwarding the first test data frame back to the wireless station; the wireless station receiving the first test data frame from the access point; and determining that the first encryption key information and the first encryption key ID of the wireless station match that of the access point in response to the wireless station receiving the first test data frame from the access point.

An exemplary embodiment of a method of verifying wired-equivalent privacy (WEP) key information for a WLAN station is disclosed. The infrastructure wireless local network contains an access point, and the wireless network conforms to the IEEE 802.11 networking standard. The method comprises: generating a first test data frame with the wireless station in which a destination address of the first test data frame is a media access control (MAC) address of the wireless station; encrypting the first test data frame with a first encryption key corresponding to a first encryption key ID; the access point decrypting the first test data frame, reading the destination address, re-encrypting the first test data frame, and forwarding the first test data frame back to the wireless station; the wireless station receiving the first test data frame from the access point; and determining that the first encryption key information and the first encryption key ID of the wireless station match that of the access point in response to the wireless station receiving the first test data frame from the access point.

### BRIEF DESCRIPTION OF THE DRAWINGS

FIG. 1 is a diagram illustrating a conventional WLAN.

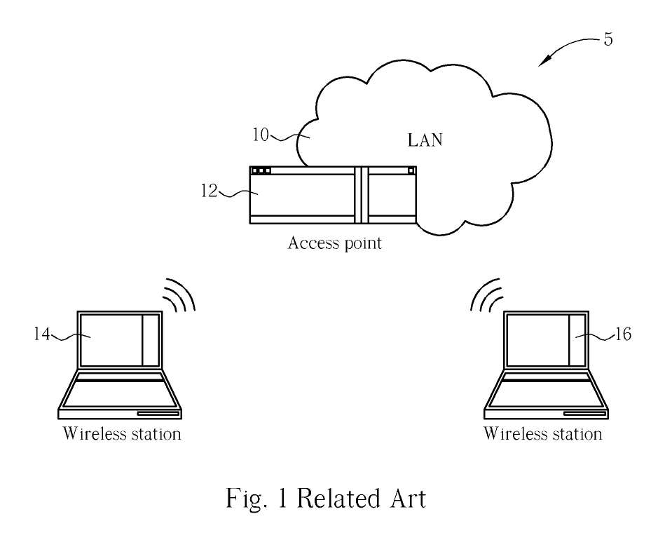

FIG. 2 illustrates data frame forwarding in a WLAN.

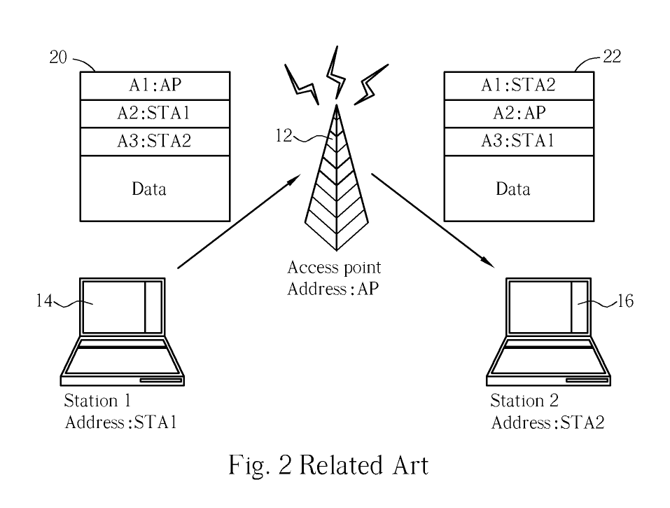

FIG. 3 illustrates sending encrypted test data frames for verifying that the key information of a wireless station matches that of an access point.

FIG. 4 illustrates a case in which the key information of the wireless station does not match that of the access point.

### DETAILED DESCRIPTION

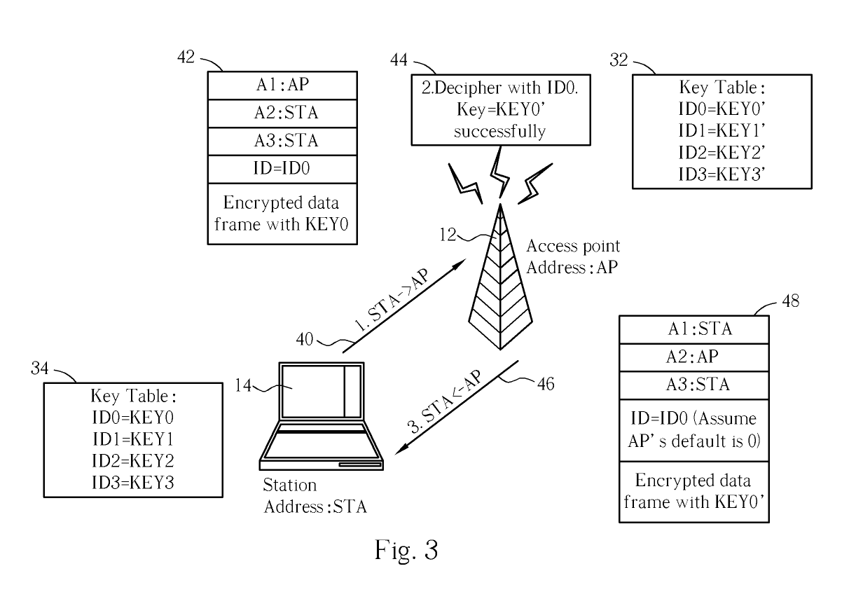

In order to quickly verify whether key information for a wireless station matches that of an access point, test data frames can be sent from the wireless station to the access point, and then forwarded back to the wireless station from the access point. Please refer to FIG. 3. FIG. 3 illustrates sending encrypted test data frames for verifying that the key information of a wireless station 14 matches that of an access point 12. The wireless station 14 has a key table 34 containing four key IDs ID0-ID3 and their respective keys KEY0-KEY3. Similarly, the access point 12 also has a key table 32 containing four key IDs ID0-ID3 and their respective keys KEY0′-KEY3′.

Immediately after configuring the wireless station 14 to communicate with the access point 12, the wireless station 14 will generate a test data frame 42 to be sent to the access point 12. The data of the test data frame 42 is encrypted with the key corresponding to key ID ID0. In addition to the encrypted data and the key ID, the test data frame 42 also contains three addresses: A1, A2, and A3. Address A1 indicates the immediate destination of the test data frame 42, which is the access point 12. Address A2 indicates the immediate source of the test data frame 42, which is the wireless station 14. Address A3 indicates the final target of the test data frame 42, which is also the wireless station 14. Thus, the test data frame 42 is intended to be forwarded back to the wireless station 14 in order to verify that the wireless station 14 uses the same key ID and key information as the access point 12.

The address A3 indicating the final target can be implemented in at least two different ways. The preferred way is to use the media access control (MAC) address of the wireless station 14 as the address A3, which will have the effect of forwarding the data frame back to the wireless station 14. Another way would be to use a group casting MAC address, such as the broadcasting address FF:FF:FF:FF:FF:FF. In either case, the wireless station 14 would be able to receive the test data frame if its key information is correct. Thus, this can verify that it is using the correct key information.

The verification process contains three steps, which are illustrated in FIG. 3. The first step is shown as arrow 40, in which the test data frame 42 is sent from the wireless station 14 to the access point 12. The second step is shown as block 44, in which the access point 12 attempts to decrypt the test data frame 42 with the key corresponding to key ID ID0 in the key table 32. The example shown in FIG. 3 assumes that the respective keys corresponding to key ID ID0 for the wireless station 14 and the access point 12 are the same. That is, KEY0=KEY0′. Therefore, the access point 12 is able to decrypt the test data frame 42 since the key information of the access point 12 matches that of the wireless station 14. The third step is illustrated in arrow 46, in which the access point 12 generates an encrypted test data frame 48 and forwards the test data frame 48 to air, which is then received by the wireless station 14.

The data of the test data frame 48 is encrypted with the key corresponding to key ID ID0, since this is assumed to be the default key ID for the access point 12. In addition to the encrypted data and the key ID, the test data frame 48 also contains three addresses: A1, A2, and A3. Address A1 indicates the immediate destination of the test data frame 48, which is the wireless station 14. Address A2 indicates the immediate source of the test data frame 48, which is the access point 12. Address A3 indicates the original source of the test data frame 48, which is also the wireless station 14.

When the wireless station 14 receives the test data frame 48 from the access point 12, the wireless station 14 then knows that the key information corresponding to the key ID that was used in the test data frame 42 matched that of the access point 12. In this example, the wireless station 14 is able to determine that KEY0=KEY0′ since they both correspond to the key ID ID0. The wireless station 14 can then send additional test packets to the access point 12 in order to test the key information corresponding to the other key IDs ID1-ID3.

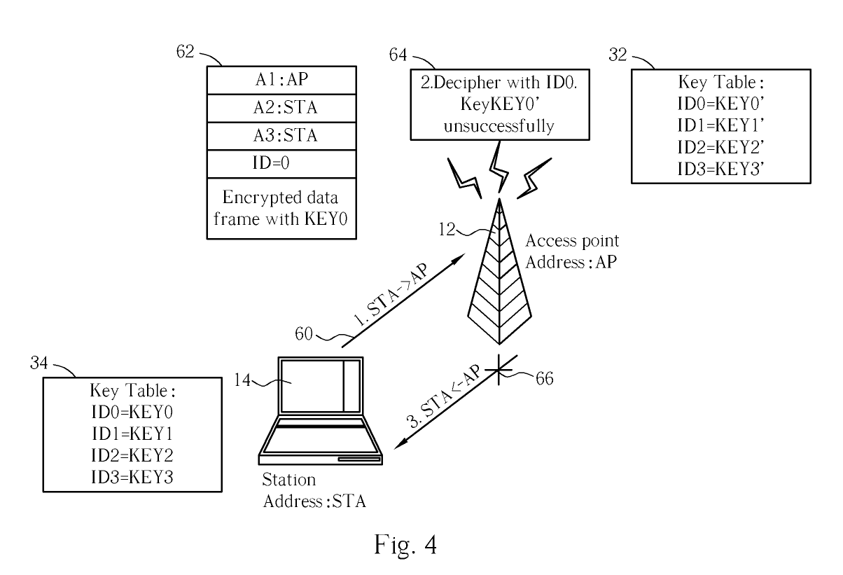

Please refer to FIG. 4. FIG. 4 illustrates a case in which the key information of the wireless station 14 does not match that of the access point 12. The key tables 32 and 34 shown in FIG. 4 are the same as those in FIG. 3. Immediately after configuring the wireless station 14 to communicate with the access point 12, the wireless station 14 will generate a test data frame 62 to be sent to the access point 12. This test data frame 62 is identical to test data frame shown 42 shown in FIG. 3. Unlike the example in FIG. 3, however, the key information corresponding to key ID ID0 for the wireless station 14 does not match the key information corresponding to key ID ID0 for the access point 12.

The first step in the verification process is shown as arrow 60, in which the test data frame 62 is sent from the wireless station 14 to the access point 12. The second step is shown as block 64, in which the access point 12 attempts to decrypt the test data frame 62 with the key corresponding to key ID ID0 in the key table 32. The example shown in FIG. 4 assumes that the respective keys corresponding to key ID ID0 for the wireless station 14 and the access point 12 do not match. That is, KEY0 is not equal to KEY0′. Therefore, the access point 12 is not able to decrypt the test data frame 62. For this reason, the third step, illustrated as arrow 66, is never executed since the access point 12 is not able to successfully decrypt the test data frame 62.

In the event that the key information for a key ID of the wireless station 14 does not match that of the access point 12, the user can try re-entering the key information of that key ID. Otherwise, a different key ID could be tried instead.

In summary, the above method offers a quick way to verify key information entered in a wireless station that communicates with an access point using WEP encryption in the IEEE 802.11 standard for wireless communication. The device can generate four test data frames and each has different key ID value. In this way, all keys used in the wireless station can quickly be verified without waiting for traffic to be generated by other devices.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of verifying wired-equivalent privacy (WEP) key information for a wireless station in a wireless network comprising an access point, the method comprising:
generating a first test data frame with the wireless station in which a destination address of the first test data frame is an address of the wireless station;
encrypting the first test data frame with a first encryption key corresponding to a first encryption key ID;
the access point decrypting the first test data frame, reading the destination address, re-encrypting the first test data frame, and forwarding the first test data frame back to the wireless station;
the wireless station receiving the first test data frame from the access point; and
determining that the first encryption key information and the first encryption key ID of the wireless station match that of the access point in response to the wireless station receiving the first test data frame from the access point.

2. The method of claim 1, wherein the address of the first test data frame is a media access control (MAC) address of the wireless station.

3. The method of claim 1, wherein the address of the first test data frame is a broadcasting address used for broadcasting the first test data frame to all wireless stations in the wireless network.

4. The method of claim 1, wherein the wireless network conforms to the IEEE 802.11 networking standard.

5. The method of claim 1, further comprising:
generating a second test data frame with the wireless station encrypted with a second encryption key corresponding to a second encryption key ID, in which a destination address of the second test data frame is an address of the wireless station; and
determining that the second encryption key and the second encryption key ID of the wireless station match that of the access point in response to the wireless station receiving the second test data frame from the access point.

6. A method of verifying wired-equivalent privacy (WEP) key information for a wireless station in a wireless network comprising an access point, the wireless network conforming to the IEEE 802.11 networking standard, the method comprising:
generating a first test data frame with the wireless station in which a destination address of the first test data frame is a media access control (MAC) address of the wireless station;
encrypting the first test data frame with a first encryption key corresponding to a first encryption key ID;
the access point decrypting the first test data frame, reading the destination address, re-encrypting the first test data frame, and forwarding the first test data frame back to the wireless station;
the wireless station receiving the first test data frame from the access point; and
determining that the first encryption key information and the first encryption key ID of the wireless station match that of the access point in response to the wireless station receiving the first test data frame from the access point.

7. The method of claim 6, further comprising:
generating a second test data frame with the wireless station encrypted with a second encryption key corresponding to a second encryption key ID, in which a destination address of the second test data frame is an address of the wireless station; and
determining that the second encryption key and the second encryption key ID of the wireless station match that of the access point in response to the wireless station receiving the second test data frame from the access point.
